(19) United States
(12) Patent Application Publication
(10) Pub. No.: US 2015/0127799 A1
(43) Pub. Date: May 7, 2015

(54) HIERARCHICAL DISTRIBUTION OF CONTROL INFORMATION IN A MASSIVELY SCALABLE NETWORK SERVER

(71) Applicant: RIFT.io Inc., Burlington, MA (US)

(72) Inventors: Matthew Harper, Salem, NH (US); Timothy Mortsolf, Amherst, MA (US)

(21) Appl. No.: 14/483,209

(22) Filed: Sep. 11, 2014

Related U.S. Application Data
(60) Provisional application No. 61/899,957, filed on Nov. 5, 2013.

(51) Int. Cl. H04L 12/24; G06F 17/30

(52) U.S. Cl. CPC H04L 41/0246; H04L 41/08; G06F 17/30212
USPC 709/223

(57) ABSTRACT

A method of propagating an FCAPS operation through a plurality of servers including a configuration server connected on a network. The method includes the steps of: receiving, by the configuration server, an FCAPS operation; the configuration server selecting a server from the plurality of servers to be lead management aggregator; the configuration server transferring the FCAPS operation to the lead management aggregator; the lead management aggregator selecting a plurality of first deputy servers from the plurality of servers; and the lead management aggregator transferring the FCAPS operation to each of the first deputy servers.

### BACKGROUND

The present invention relates to systems and methods for distribution of control information in a network server.

Distributed network services traditionally partition control operations into differentiated processes that each play separate roles in the processing of control and management functions. The SAF (service availability framework) partitions the hardware components for control operations into an active/standby pair of centralized system controller nodes and a variable set of control nodes. The SAF model also supports a 3-tier set of software processes that process the control functions across a distributed system; these processes are termed “director”, “node director”, and “agents” (FIG. 1).

A two-tier process model is commonly used in Linux to manage distributed network services on a single node (FIG. 2). Tier 1 includes inetd process registers on one or more TCP/IP ports, each port being tied to a separate network service. When a remote client connects to one of these ports, the inetd process then starts (in Tier 2) a separate network process that services all of the TCP/IP traffic for that socket. A configuration file specifies the TCP/IP port numbers that the inetd process registers in order to listen for inbound connections along with the corresponding server process to start when a connection is established to a port.

Modern messaging packages provide a messaging library used by clients to send and receive messages and a message broker that controls the distribution of messages between the messaging clients (FIG. 3). Many messaging packages support both a topic publish/subscribe and a message queue service. In the publish/subscribe model, some clients subscribe to a topic for which they wish to receive messages, while other clients publish messages to the topic. The message broker routes messages from the publisher to any subscribers that have registered for the topic.

In each of the three presented networking services, a centralized architecture is used to distribute control and management functions. Within the SAF architecture, the active/standby system controller initiates all of the high level management functions for a SAF service (FIG. 1). In the Linux inetd network service system programming model, the single inetd process on a host manages the initial TCP/IP network socket connections to the server (FIG. 2). A message broker is a centralized messaging process that routes all of the messages associated with a topic within a cluster to each messaging client that has subscribed to the particular topic (FIG. 3).

### SUMMARY

A problem with the centralized architectures described above is that they cannot scale to systems that support thousands of nodes or clients because of centralized bottlenecks that constrain the rate of control or management functions that can be initiated within a distributed system.

Accordingly, the invention disclosed herein includes methods and systems for distributing control and management functions to achieve much better scalability than is possible with centralized control architectures. A system according to embodiments of this invention will be able to perform control functions across thousands of independent computer hosts in real-time. In some embodiments, the invention will be capable of processing thousands of control operations per second, with each control operation being processed by ten thousand or more hosts that are interconnected via a low latency network.

In one embodiment, a method of propagating an FCAPS operation through a plurality of servers including a configuration server connected on a network. The method includes the steps of: receiving, by the configuration server, an FCAPS operation; the configuration server selecting a server from the plurality of servers to be lead management aggregator; the configuration server transferring the FCAPS operation to the lead management aggregator; the lead management aggregator selecting a plurality of first deputy servers from the plurality of servers; and the lead management aggregator transferring the FCAPS operation to each of the first deputy servers.

In another embodiment, a system for propagating an FCAPS operation. The system includes a plurality of servers including a configuration server connected on a network to at least one client. The configuration server is configured to receive an FCAPS operation from the client, select a server from the plurality of servers to be lead management aggregator, and transfer the FCAPS operation to the lead management aggregator. The lead management aggregator is configured to select a plurality of first deputy servers from the plurality of servers, and transfer the FCAPS operation to each of the first deputy servers.

Other aspects of the invention will become apparent by consideration of the detailed description and accompanying drawings.

### BRIEF DESCRIPTION OF THE DRAWINGS

FIG. 1 shows a diagram of how the SAF (service availability framework) partitions the hardware components for control operations.

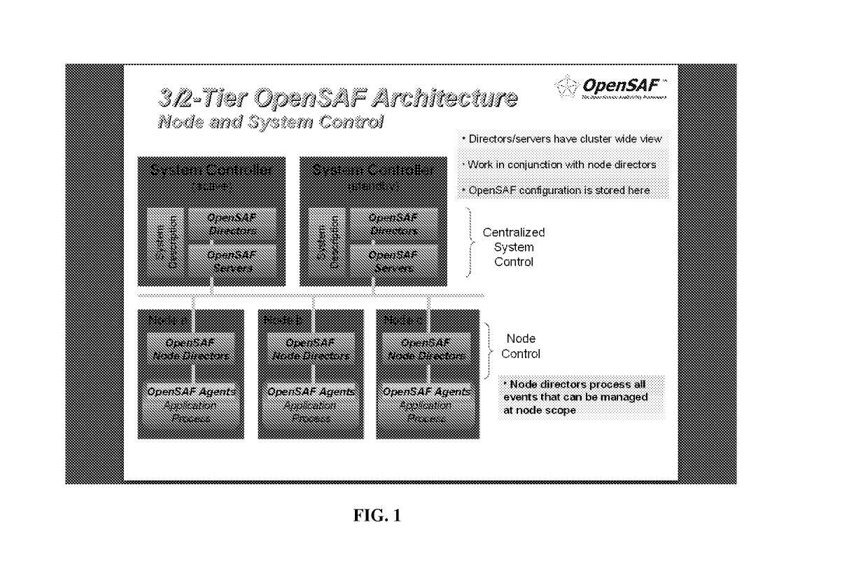

FIG. 2 shows a diagram of a two-tier process model as is commonly used in Linux to manage distributed network services on a single node.

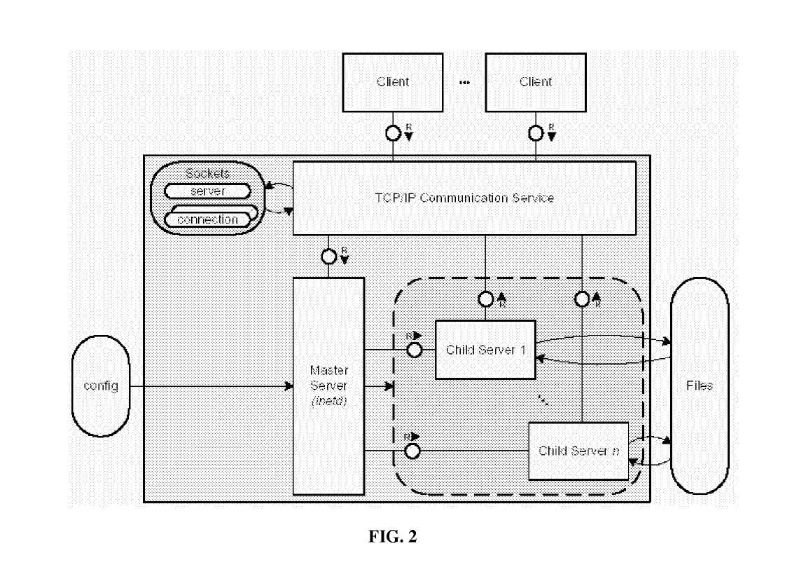

FIG. 3 shows a diagram of a messaging package including a messaging library and a message broker.

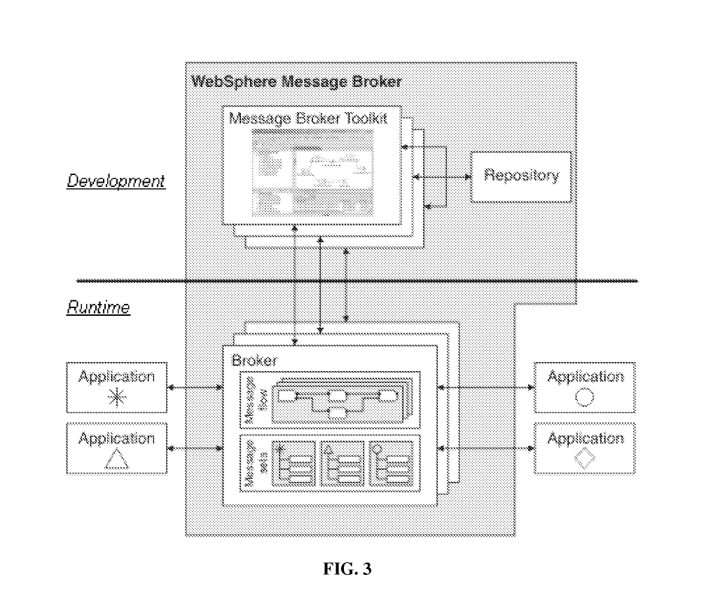

FIG. 4 shows a diagram of a system for carrying out embodiments of the present invention.

FIG. 5 shows a diagram of a sharded system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In various embodiments, the invention includes methods and systems for hierarchical distribution of control information in a massively scalable network server. The methods and systems are carried out using a plurality of servers that are connected using a network, of which various connections may be made in a wired or wireless manner and may be connected to the Internet. Each server may be implemented on a single standalone device or multiple servers may be implemented on a single physical device. Each server may include a controller, where one or more of the controllers includes a microprocessor, memory, and software (e.g. on a computer-readable medium including non-transient signals) that is configured to carry out the present invention. One or more servers may include input and output capabilities and may be connected to a user interface.

The invention partitions a plurality of hosts in a cluster to run two types of elements, namely the configuration database (confdb) servers and the network service servers. Clients connect to the configuration servers to perform network control and management functions, which are often referred to as FCAPS operations (Fault, Configuration, Accounting, Performance, and Security) in the networking industry; also referred to herein as a transaction. The protocols used to convey these FCAPS operations between a client and a configuration server are defined by Internet TCP/IP protocol standards and use TCP or UDP transport protocols to carry the network management packets. Network management protocols that are supported include, but are not limited to, NETCONF, SNMP, SSH CLI, and JSON/HTTP. Each network operation is load balanced from the client to one of the configuration servers using a standard TCP/IP load balancer.

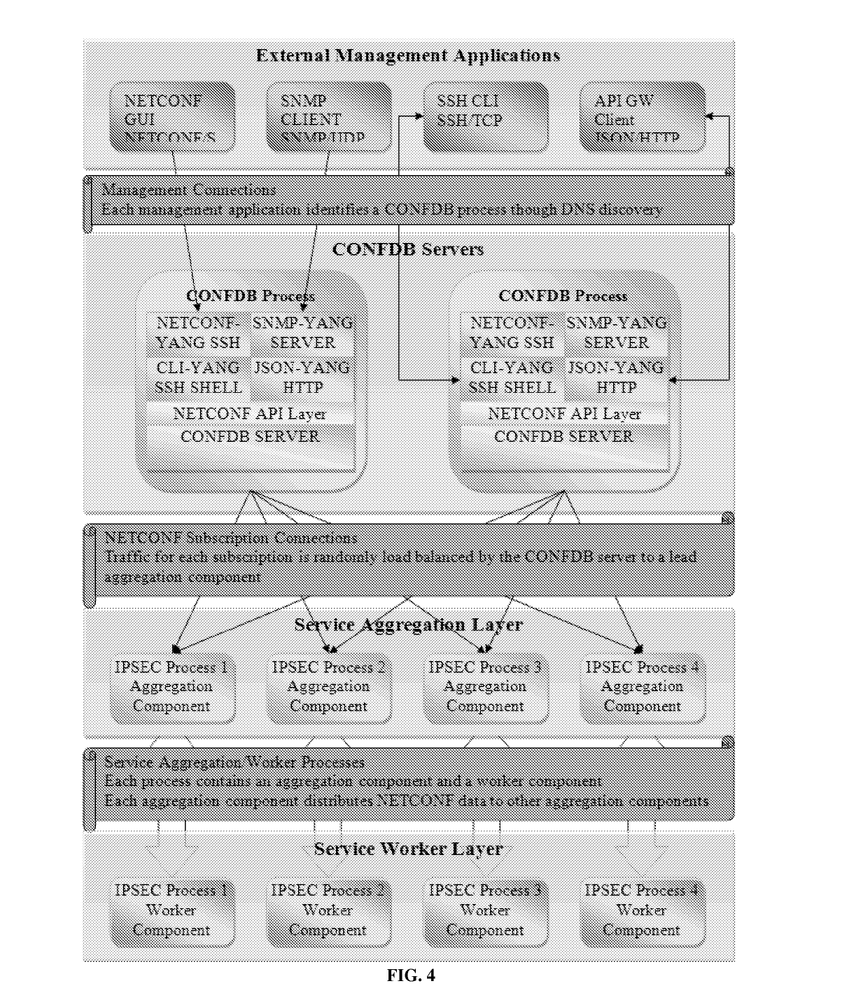

FIG. 4 shows a diagram of a system for executing embodiments of the invention. One or more external management applications needing to execute an FCAPS operation identifies a CONFDB process through DNS discovery, thereby establishing a connection with a configuration database (CONFDB) server. The configuration database servers identify a lead aggregation component (also referred to as a lead management aggregator) in a service aggregation/service worker layer. Each of these components proceeds to execute the FCAPS operation as discussed below.

The configuration servers perform configuration operations that store and retrieve management information (e.g. set or modify a configuration element within the configuration database) and operational operations (or network service operation) that look up the running administrative state of network services running within the cluster (e.g. return information from the configuration database). The configuration database may be fully replicated across all of the configuration servers within a cluster. Alternatively, in some embodiments the database may be sharded, so that certain elements are processed by a subset of the configuration servers. When the configuration database is sharded, modifications to the configuration require locking the configuration databases within a shard so that atomic updates to configuration elements occur across the network elements that participate within an individual shard. As discussed further below, a shard refers to a subgroup of servers within a cluster which share a common property such as housing portions of a shared database. Increasing the number of shards reduces the percentage of network servers that are locked when a configuration item is updated, which in turn increases the transaction rate and scalability of network configuration services. Operational operations do not require locking and may or may not also be sharded across the configuration database servers.

When a configuration server receives a configuration change to the database, it propagates the change to all of the network servers that are managed by the configuration changeset (i.e. a set of changes that is treated as an indivisible group) that has been applied. Any one of the network servers in the cluster can handle configuration and administrative events for any network service that has been configured within the cluster. The configuration server dynamically selects one of these network servers to act as the “lead management aggregator” (LMA) for a particular network management operation. This selection can be made using a random selection, a load based selection, or a round-robin LRU (least-recently used) algorithm. The LMA uses a hierarchical distribution algorithm to distribute an FCAPS operation to the remaining network systems within the cluster. The LMA picks a small set (on the order of 2 to 5) of “management deputies” to apply the unfulfilled management operation. Each of this first line of deputies enrolls a small set (also on the order of 2 to 5) additional deputies to further propagate the management operation. In various embodiments, the number of deputies selected at each level can be different and can range from 2 to 5, 10, 20, 50, 100, or any other number of deputies. This pattern continues until every network server within the cluster has received and processed the management operation. A cluster for these purposes may include a set of addressable entities which may be processes, where some of the processes may be on the same server. In some embodiments, two or more of the addressable entities within a cluster may be in the same process. The cluster is separated into shards for particular transactions (see below). When an item is replicated across the cluster it is replicated only to those members of the cluster that have been denoted as participating in the shard to which the item belongs. In various embodiments, there is a separate framework including a controller which performs cluster management including tracking membership; the hierarchical control system uses this framework as input to determine which members participate within each shard. This framework is a dynamic entity that expands and contracts as servers enter and leave the system.

To show how quickly the operation can propagate, the following list shows the number of network servers that will process a management operation at each level of hierarchical distribution in a particular example. Assume that the LMA picks 5 primary deputies, and each of these 5 primary deputies pick 5 secondary deputies, and so on:
LMA: 1 network server
1st deputy level: 1 LMA+5 1st level deputies=6 network servers
2nd deputy level: 1+5+5*5=31 network servers
3rd deputy level: 1+5+5*5+5*5*5=156 network servers
4th deputy level: 1+5+5*5+5*5*5+5*5*5*5=781 network servers

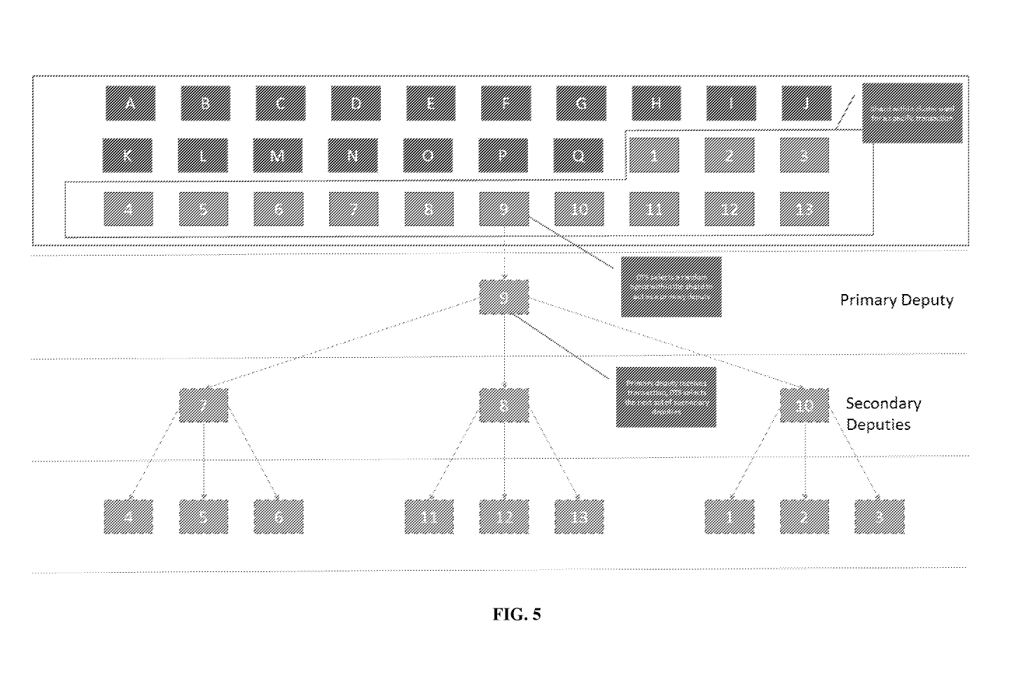

FIG. 5 shows a diagram of a sharded system. The diagram in FIG. 5 shows a cluster of thirty servers (although the cluster may have any number) labeled A-Q and 1-13. In this particular example, servers 1-13 are a shard within the cluster which are used for a specific transaction. A transaction can include configuration operations and operational operations as discussed above. Any subgroup of servers may be placed into a shard for a given transaction and the servers within the cluster and/or shard do not have to be in the same physical location. In this transaction, the configuration server selects one of the servers within the shard to be the primary deputy. The primary deputy receives the transaction and subsequently selects several other servers from the shard (three servers in this example) to be secondary deputies. Each of the secondary deputies in turn recursively selects a group of third level deputies, etc. until all of the servers within the shard have been recruited. As seen in FIG. 5, only three levels are needed to recruit all thirteen of the servers in the shard, each of which is required to recruit at most three other servers. As discussed this procedure can be used with larger numbers of servers, each of which may recruit a larger number of deputies at each level, to propagate a transaction through a network of servers with a high degree of efficiency.

In various embodiments, some or all of the above-described activities ascribed to the LMA, the primary deputy, and the secondary and other deputies may be mediated by calls to a distributed transaction system (DTS) library (FIG. 5). In such embodiments, the DTS library may be used by FCAPS (e.g. to initiate the distribution of transactions) and/or by the LMA or deputies (e.g. to propagate the distribution of transactions).

For configuration operations, the LMA processes the configuration and if successful, it then propagates the configuration operation to the next set of deputies using the procedure described above. If an error is present in the configuration, then the LMA will not propagate the configuration change any further within the cluster. Once the LMA propagates the configuration change to its first line of deputies, these deputies process the configuration and distribute the configuration change to the second line of deputies. Any network servers other than the LMA that cannot successfully apply the configuration change are not consistent with the cluster and remove themselves from the group until they can resynchronize their configuration database with the group. In various embodiments, one or more servers are maintained as ‘authoritative sources’ which are used as a reference that can be used to resynchronize the configuration database of a network server.

When a configuration change is applied, there are certain cases that may result in an error, indicating that the configuration change cannot be successfully applied. These cases typically occur when references to other entities result in an error. For example, if an IP address is assigned to an interface and the interface does not exist, that would be an error. If every other member of the cluster could apply the change because that interface is visible to them and the singular member could not, then the singular member would be removed from the cluster because it is inconsistent with the rest of the members in the cluster.

For network service operations, the LMA distributes the operational command to the first set of deputies and waits for a response. Each deputy in turn distributes the operational command to the next set of deputies until the bottom level of nodes have been contacted. These nodes then process the operational command and return the data to the deputies that contacted them. The LMA and each deputy aggregate the responses into a single operational response that they return to the caller that invoked them. The configuration server that initiated the operational operation receives an aggregated operational response from the LMA.

Various features and advantages of the invention are set forth in the following claims.

What is claimed is:

1. A method of propagating an FCAPS operation through a plurality of servers including a configuration server connected on a network, the method comprising the steps of:
receiving, by the configuration server, an FCAPS operation;
the configuration server selecting a server from the plurality of servers to be lead management aggregator;
the configuration server transferring the FCAPS operation to the lead management aggregator;
the lead management aggregator selecting a plurality of first deputy servers from the plurality of servers; and
the lead management aggregator transferring the FCAPS operation to each of the first deputy servers.

2. The method of claim 1, wherein the FCAPS operation comprises a network service operation and wherein the lead management aggregator transferring the network service operation to each of the first deputy servers further comprises the lead management aggregator waiting for a response from each of the first deputy servers.

3. The method of claim 2, further comprising
each of the first deputy servers returning a response to the lead management aggregator;
the lead management aggregator aggregating the responses from each of the first deputy servers into an operational response; and
the lead management aggregator returning the operational response to the configuration server.

4. The method of claim 1, wherein each first deputy server selects a plurality of second deputy servers and wherein each first deputy server sends the FCAPS operation to each of the second deputy servers.

5. The method of claim 1, wherein selecting a server to be the lead management aggregator comprises selecting using one of a random selection, a load based selection, and a round-robin LRU algorithm.

6. The method of claim 1, wherein the lead management aggregator selects at least two and no more than five first deputy servers.

7. The method of claim 1, wherein the FCAPS operation comprises a configuration change, wherein the lead management aggregator comprises a database, and wherein the configuration change is applied to the database of the lead management aggregator.

8. The method of claim 7, wherein the step of the lead management aggregator transferring the FCAPS operation to each of the first deputy servers comprises the lead management aggregator transferring the FCAPS operation to each of the first deputy servers if the configuration change is successfully applied to the database of the lead management aggregator.

9. The method of claim 7, wherein each of the plurality of servers comprises a database and wherein the configuration change is applied to the database of each of the first deputy servers.

10. The method of claim 9, wherein for each of the first deputy servers that cannot successfully apply the configuration change to its database, that first deputy server is removed from the plurality of first deputy servers.

11. The method of claim 10, wherein the database of the first deputy server that is removed is resynchronized.

12. The method of claim 9, wherein the databases of each of the plurality of servers are fully replicated databases.

13. The method of claim 9, wherein the lead management aggregator, the first deputy servers, and the second deputy servers comprise a shard.

14. A system for propagating an FCAPS operation, comprising:
a plurality of servers including a configuration server connected on a network to at least one client,
the configuration server being configured to
receive an FCAPS operation from the client,
select a server from the plurality of servers to be lead management aggregator, and
transfer the FCAPS operation to the lead management aggregator;
the lead management aggregator being configured to
select a plurality of first deputy servers from the plurality of servers, and
transfer the FCAPS operation to each of the first deputy servers.

15. The system of claim 14, wherein the FCAPS operation comprises a network service operation and wherein the lead management aggregator, after transferring the FCAPS operation to each of the first deputy serves, is further configured to wait for a response from each of the first deputy servers.

16. The system of claim 15, wherein
each of the first deputy servers is configured to
return a response to the lead management aggregator,
the lead management aggregator is further configured to
aggregate the responses from each of the first deputy servers into an operational response, and
return the operational response to the configuration server.

17. The system of claim 14, wherein each first deputy server is configured to
select a plurality of second deputy servers, and
send the FCAPS operation to each of the second deputy servers.

18. The system of claim 14, wherein the configuration server is configured to select a server to be the lead management aggregator using one of a random selection, a load based selection, and a round-robin LRU algorithm.

19. The system of claim 14, wherein the lead management aggregator is configured to select at least two and no more than five first deputy servers.

20. The system of claim 14, wherein the FCAPS operation comprises a configuration change, wherein the lead management aggregator comprises a database, and wherein the lead management aggregator is further configured to apply the configuration change to the database.

21. The system of claim 20, wherein the lead management aggregator is further configured to transfer the FCAPS operation to each of the first deputy servers if the configuration change is successfully applied to the database of the lead management aggregator.

22. The system of claim 20, wherein each of the plurality of servers comprises a database and wherein each of the first deputy servers is further configured to apply the configuration change to its database.

23. The system of claim 22, wherein for each of the first deputy servers that cannot successfully apply the configuration change to its database, the lead management aggregator is further configured to remove that first deputy server from the plurality of first deputy servers.

24. The system of claim 23, wherein the database of the first deputy server that is removed is resynchronized.

25. The system of claim 22, wherein the databases of each of the plurality of servers are fully replicated databases.

26. The system of claim 17, wherein the lead management aggregator, the first deputy servers, and the second deputy servers comprise a shard.

27. A method of recursively propagating an FCAPS operation through a plurality of servers including a configuration server connected on a network, the method comprising the steps of:
receiving, by the configuration server, an FCAPS operation;
the configuration server selecting a server from the plurality of servers to be lead management aggregator;
the configuration server transferring the FCAPS operation to the lead management aggregator;
the lead management aggregator recursively selecting a plurality of deputy servers from the plurality of servers; and
the lead management aggregator transferring the FCAPS operation to each of the deputy servers, wherein the FCAPS operation is recursively propagated through the plurality of deputy servers.

28. The method of claim 27, wherein the plurality of servers comprises a shard, the shard being a subset of the plurality of servers, the shard including the lead management aggregator and the plurality of deputy servers.
